(19) United States
(12) Patent Application Publication
(10) Pub. No.: US 2009/0162579 A1
(43) Pub. Date: Jun. 25, 2009

(54) PLAY SURFACE LAYER STRUCTURE

(76) Inventor: Rodrigue McDUFF, St-Bruno (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/358,544

(22) Filed: Jan. 23, 2009

Related U.S. Application Data
(63) Continuation-in-part of application No. PCT/CA2007/001310, filed on Jul. 23, 2007.
(60) Provisional application No. 60/820,132, filed on Jul. 24, 2006.

(51) Int. Cl. A41G 1/00; B32B 3/10

(52) U.S. Cl. 428/17; 428/86

(57) ABSTRACT

A play surface layer structure comprises a base layer having panels joined in side-by-side relation. Each of the panels is formed of an impact-absorbing material. A surface layer has carpeting panels positioned in side-by-side relation atop the base layer so as form an exposed surface of the play surface layer structure. Textile interfaces are between the base layer and the surface layer. The interfaces secure the surface layer to the base layer.

### CROSS-REFERENCE TO RELATED APPLICATIONS

This patent application is a continuation in part of PCT Patent Application No. PCT/CA2007/001310, filed on Jul. 23, 2007, and claims priority on U.S. Provisional Patent Application No. 60/820,132, filed on Jul. 24, 2006.

### FIELD OF THE APPLICATION

The present application relates to play surfaces of synthetic materials and, more particularly but not exclusively, to a layer structure for play surfaces and to a method of assembling a play surface with such layer structure.

### BACKGROUND OF THE ART

In playgrounds and sports fields, play surfaces have evolved to depart from the hard materials previously used, such as concrete, asphalt or the like. For instance, known turf surfaces currently used are simply a layer of a polymeric carpeting laid upon concrete.

United States Publication No. 2004/0209038, by Foxon and as published on Oct. 21, 2004, describes a playing surface structure. In this structure, the top layer has a surface carpet layer that is secured to a resin-impregnated textile layer. A stratified fibrous material is provided between the top layer and the substrate (e.g., concrete). Amongst others, the stratified fibrous material is used as an impact-absorbing layer.

The quality of installation of similar playing surface structures is dependent on the experience of the manpower used. The material forming the layers typically comes in the form of rolls, and adhesives such as tape are used for installation. Moreover, the playing surface structures offer weaker zones at the joint between panels of a same layer. The installation costs are therefore relatively expensive for similar playing surface structures.

### SUMMARY OF THE APPLICATION

It is therefore an aim of the present invention to provide a play surface layer structure that addresses issues associated with the prior art.

Therefore, in accordance with the present invention, there is provided a play surface layer structure, comprising: a base layer having panels joined in side-by-side relation, each of the panels being formed of an impact-absorbing material; a surface layer having carpeting panels positioned in side-by-side relation atop the base layer so as form an exposed surface of the play surface layer structure; and textile interfaces between the base layer and the surface layer, the textile interfaces securing the surface layer to the base layer.

Further in accordance with the embodiments, the panels of the base layer are joined in side-by-side relation by any one of flange-and-shoulder and tongue-and-groove configurations.

Still further in accordance with the embodiments, the textile interfaces are hook-type Velcro™ strips cooperating directly with a textile subpanel of the carpeting panels.

Still further in accordance with the embodiments, an underside of the surface layer has a sublayer of hoop-type Velcro™.

Still further in accordance with the embodiments, recesses are defined in an upper surface of the panels of the base layer to accommodate the textiles interfaces such that the upper surface of the panels of the base layer is coplanar with an upper surface of the textile interfaces.

Still further in accordance with the embodiments, the textile interfaces are hook-type Velcro™ strips cooperating directly with a textile subpanel of the carpeting panels.

Still further in accordance with the embodiments, the hook-type Velcro™ strips are received in two parallel recesses provided on the contour of each of the panels of the base layer, and in a recess centrally provided in the panel of the base layer, with the recesses being parallel to one another.

Still further in accordance with the embodiments, two additional parallel recesses are provided on the contour of each of the panels of the base layer, the additional parallel recesses being perpendicular to the three other recesses.

Still further in accordance with the embodiments, the panels of the base layer are molded in expanded polyethylene.

Still further in accordance with the embodiments, the panels of the base layer are molded at a density ranging between 2.0 and 5.0 pcf.

Still further in accordance with the embodiments, the hook-type Velcro™ strips are laminated into the recess using an adhesive.

Still further in accordance with the embodiments, the adhesive used to laminate the hook-type Velcro™ strips in the recesses is a olefin-based resin.

Still further in accordance with the embodiments, the carpeting panels of the surface layer each have a fiber subpanel having upstanding fibers simulating grass, and a textile subpanel binding the fibers of the fiber subpanel together.

Still further in accordance with the embodiments, the carpeting panels further comprise a subpanel of hoop-type Velcro™ on an underside of the textile subpanel.

Still further in accordance with the embodiments, the carpeting panels are in the form of rectangular mats.

Still further in accordance with the embodiments, the carpeting panels are elongated into a roll for being installed.

Still further in accordance with the embodiments, an underbase layer has panels with a density different than the density of the panels of the base layer.

Still further in accordance with the embodiments, the panels of the underbase layer have a top surface of shape complementary to a shape of a bottom surface of the panels of the base layer for mechanical engagement therebetween.

Still further in accordance with the embodiments, the carpeting panels are positioned on the base layer such that each carpeting panel overlaps at least four of the panels of the base layer.

Still further in accordance with the embodiments, recesses are provided in an undersurface of the panels of the base layer to reduce a weight of the panels of the base layer.

### BRIEF DESCRIPTION OF DRAWINGS

FIG. 1 is a perspective assembly view of a play surface layer structure constructed in accordance with a preferred embodiment of the present disclosure;

FIG. 2A is a perspective view of a base layer panel used in the play surface layer structure of FIG. 1;

FIG. 2B is a sectional view taken along sectional lines IIB-IIB of FIG. 2A;

FIG. 2C is a sectional view taken along sectional lines IIC-IIC of FIG. 2A;

FIG. 3A is a perspective view of a base layer panel used in accordance with another preferred embodiment of the play surface layer structure;

FIG. 3B is a sectional view taken along sectional lines IIIB-IIIB of FIG. 3A;

FIG. 3C is a sectional view taken along sectional lines IIIC-IIIC of FIG. 3A;

FIG. 4 is a perspective assembly view of the base layer panels of the play surface layer structure of FIG. 1;

FIG. 5 is a schematic view of a carpeting panel used in the play surface layer structure of FIG. 1;

FIG. 6 is a schematic view illustrating a connection between the carpeting panel of FIG. 5 and an interface of the play surface layer structure of FIG. 1;

FIG. 7 is a schematic view of a carpeting panel in accordance with another preferred embodiment of the play surface layer structure;

FIG. 8 is an assembly view of a base layer panel used in accordance with another preferred embodiment of the play surface layer structure, with respect to interfaces;

FIG. 9 is a perspective view of the base layer panel of FIG. 8 with the interface assembled thereto;

FIG. 10 is the base layer panel of FIG. 8 in another configuration;

FIG. 11 is a side elevation assembly view of the play surface layer structure, with a base layer panel in accordance with yet another preferred embodiment;

FIG. 12 is a side elevation assembly view of the play surface layer structure of FIG. 11, with an underbase layer panel;

FIG. 13 is a top plan schematic view of an installation of the play surface layer structure using rolls of carpeting panel; and

FIG. 14 is a top plan schematic view of an installation of the play surface layer structure using rectangular mats of carpeting panel;

FIG. 15 is a bottom plan view of a base layer in accordance with another preferred embodiment of the present disclosure;

FIG. 16 is a top plan view of the base layer of FIG. 15;

FIG. 17 is a sectional view of the base layer of FIG. 5; and

FIG. 18 is an enlarged view of a connector of the base layer of FIG. 15.

### DESCRIPTION OF PREFERRED EMBODIMENTS

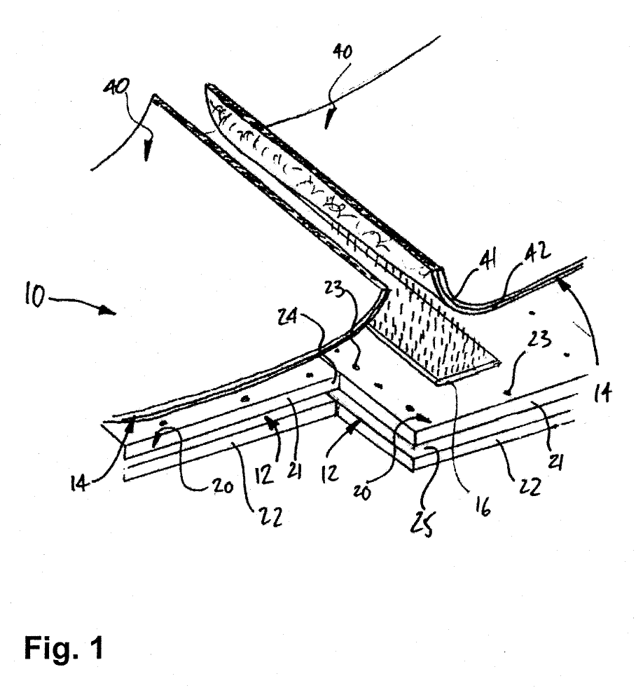

Referring now to the drawings and more particularly to FIG. 1, a play surface layer structure in accordance with a preferred embodiment is generally shown at 10. The play surface layer structure 10 has a base layer 12, a surface layer 14, and textile interfaces 16.

The base layer 12 is the bottommost layer and is laid on the ground, for instance on a substrate such as concrete, asphalt. The base layer 12 defines the impact-absorbing component of the structure 10.

The surface layer 14 is the uppermost layer and is exposed as the play surface.

The interfaces 16 secure the surface layer 14 to the base layer 12.

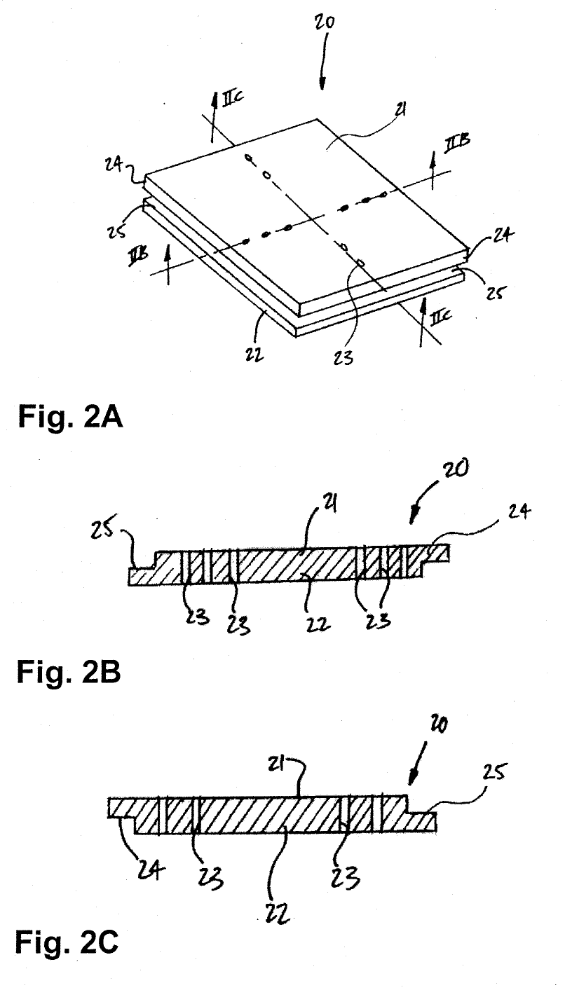

Referring to FIGS. 2A to 2C, a base layer panel of the base layer 12 is generally illustrated at 20 in accordance with the preferred embodiment. The base layer panel 20 consists of a pair of overlapping subpanels 21 and 22.

A plurality of drainage bores 23 extend from a top surface to a bottom surface of the base layer panel 20. Therefore, water reaching the panel 20 is drained through the bores 23.

The subpanels 21 and 22 are secured to one another, and are positioned with respect to one another so as to form a flange-and-shoulder joint configuration. Two edges of the base layer panel 20 form flanges 24, whereas the remaining two edges define corresponding shoulders 25.

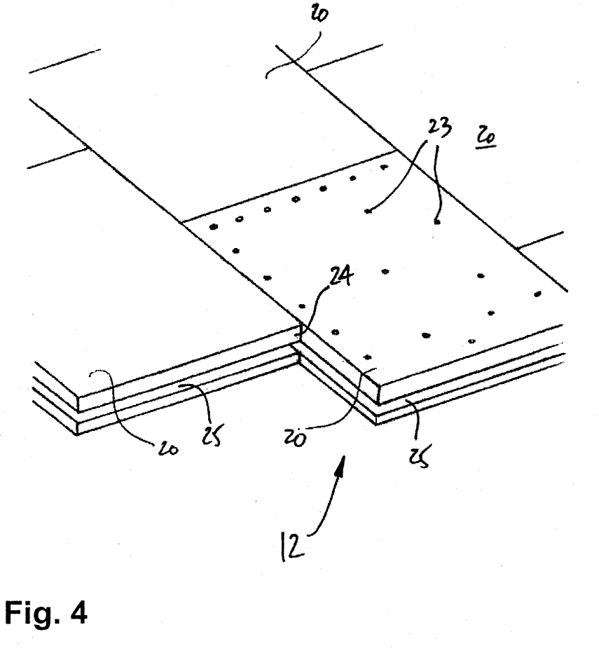

Accordingly, as shown in FIG. 4, the base layer panels 20 are positioned side by side with corresponding flanges 24 and shoulders 25. The base layer 12 is formed and defines a generally planar top surface. Adhesives or like mechanical fasteners can be used to secure the base layer panels 20.

Although the base layer panel 20 may be integrally molded in one piece, it is considered to have the subpanels 21 and 22 manufactured separately (e.g., molded, cut with hot wire, etc.) to form the flange-and-shoulder joint configuration illustrated in FIGS. 2A to 2C.

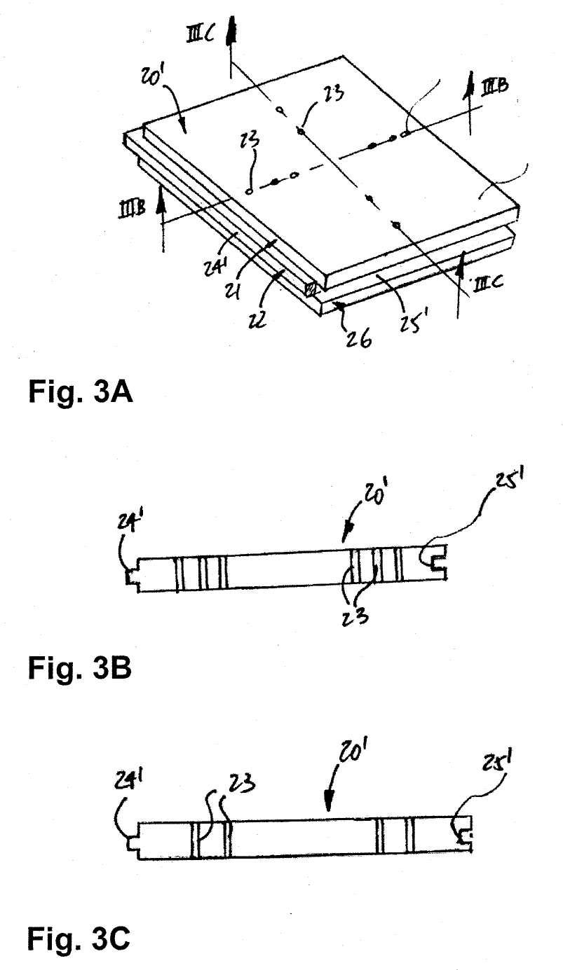

Referring to FIGS. 3A to 3C, another preferred embodiment of the base layer panel is generally shown at 20′. In FIGS. 2A to 3C, like elements for the base layer panels 20 and 20′ will bear like reference numerals. The base layer panel 20′ has a tongue-and-groove joint configuration, resulting from the use of a third subpanel 26. Accordingly, the tongue 24′ and the groove 25′ are formed.

It is pointed out that the thickness of material used is uniform throughout the base layer 12 with the flange-and-shoulder joint configuration and the tongue-and-groove joint configuration. Moreover, other types of side-by-side joints between panels 20/20′ are considered.

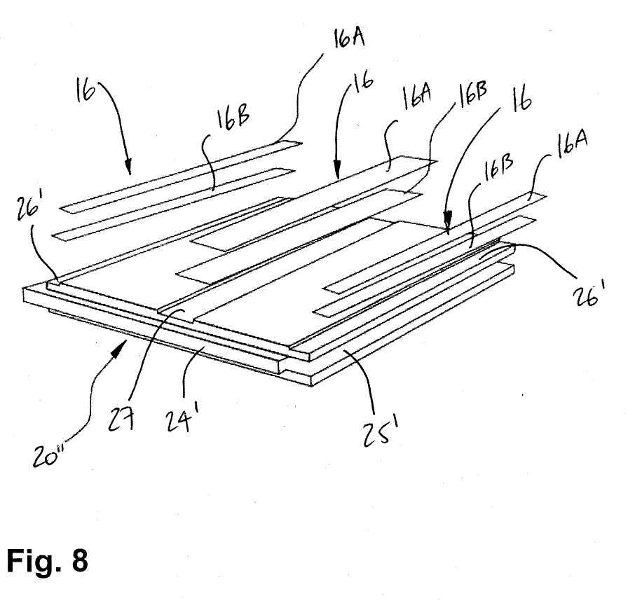

Referring concurrently to FIGS. 8-10, another preferred embodiment of the base layer panel is generally shown at 20″. The base layer panel 20″ is similar to the base layer panel 20′ (FIG. 3A) in that it has a tongue-and-groove configuration, with tongue 24′ and groove 25′.

In order to provide a generally flat surface for the carpeting panel 40 to be laid upon, the base layer panel 20″ has recesses to accommodate the interfaces 16, such that the layer 20″ and interfaces 16 form a generally planar surface when assembled (i.e., without the interfaces 16 protruding on the surface of the layer 20″).

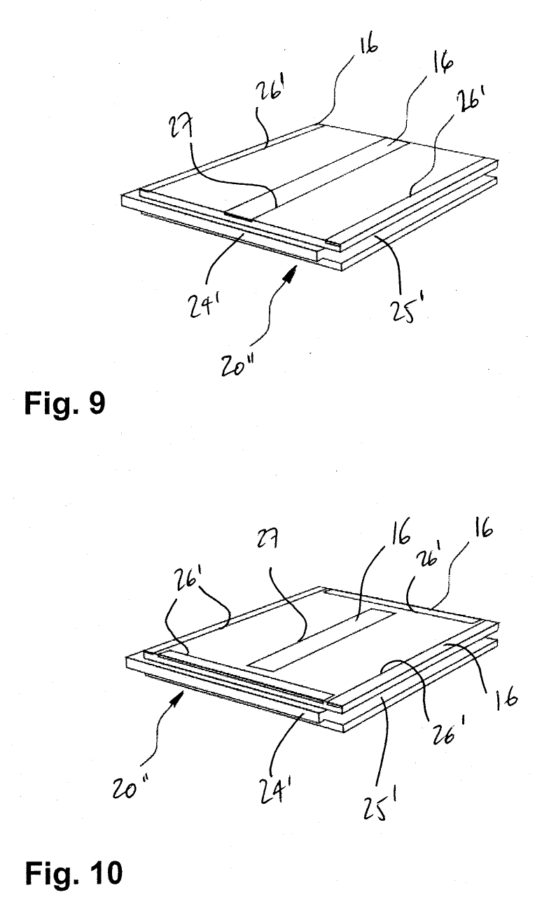

More specifically, the base layer panel 20″ has recesses 26′ and 27 on its top surface. In FIGS. 8 and 9, the recesses 26′ are on the contour of the base layer panel 20″, whereas the recess 27 is generally centrally positioned on the top surface of the base layer panel 20″. In the base layer panel 20″ of FIGS. 8 and 9, the recesses 26′ and 27 are generally parallel to one another. In the base layer panel 20″ of FIG. 10, a pair of the recesses 26′ are perpendicular to the recess 27 to provide an increased connection surface for the carpeting layer 40.

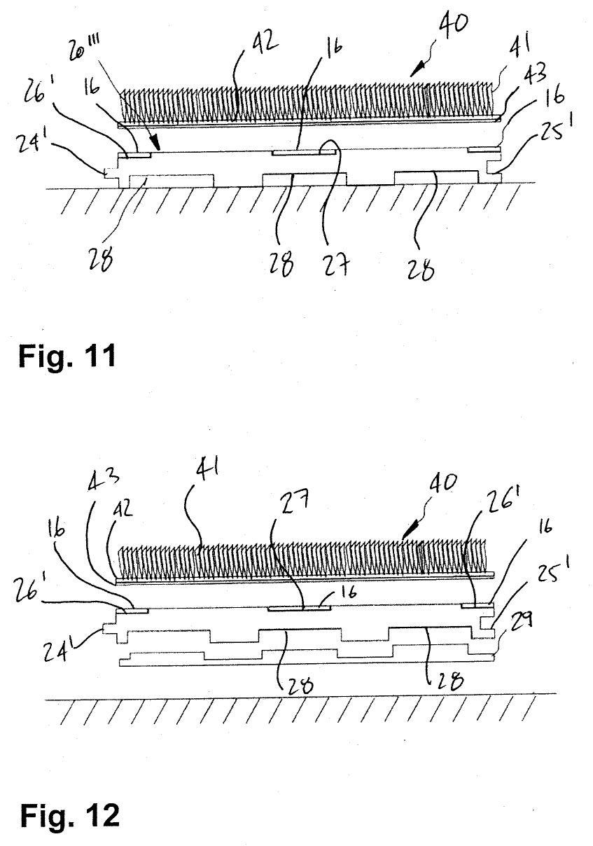

Referring to FIG. 11, another preferred embodiment of the base layer panel is generally shown at 20′″. The base layer panel 20′″ is generally similar to the base layer panel 20″ of FIGS. 8 to 10, but features weight-relief recesses 28. The recesses 28 are provided to lower the weight of the base layer panels 20′″ without affecting the thickness thereof. With the recesses 28, the panels 20′″ use less material and therefore weigh less, thereby facilitating their handling and installation.

Moreover, the recesses 28 can be used as draining channels and/or aeration channels for rainwater. The recesses 28 form an air cavity that may act as a cushion enhancing the shock absorption of the base layer panel 20′″. Accordingly, the width of the recesses 28 is selected as a function of the characteristics that are sought from the base layer panel 20′″.

Referring to FIG. 12, the base layer panel 20′″ is used with an underbase layer panel 29. The underbase panel layer 29 is used to provide a different characteristic to the play surface. As an example, the underbase layer panel 29 has a different density than the base layer panel 20′″, for instance to add some resilience to the play surface. As is shown in FIG. 12, the underbase layer panel 29 has a top surface shaped for complementary engagement with the bottom surface of the base layer panel 20′″, whereby the installation of the underbase layer panel 29 is straightforward and does not require tools. In one embodiment, the density of the base layer panel 20′″ is lesser than that of the underbase layer panel 29 to have more resilience at the surface of the play surface. The different densities are typically selected as a function of the sports that will be practiced on the play surface.

The specifications of the panels 20, 20′, 20″ and 20′″ and of the underbase layer panel 29 will depend on the required characteristics for the play surface. It is considered to use expanded polymers with some resilience and elasticity, such as expanded polyethylene, expanded polypropylene, Arcel™, or the like. The density of the material as well as the thickness of the panels 20 to 20′″ and 29 varies according to the required impact absorption for the play surface.

In another preferred embodiment, it is considered to mold the base layer panels 20 to 20′″ and the underbase layer panel 29. More specifically, as the base layer panels 20″ and 20′″ and the underbase layer panel 29 have distinct patterns with tongue-and-groove configurations and recesses, the base layer panels 20″ and 20′″ and the underbase layer panel 29 are typically molded as molding represent a cost-effective method for producing more complex parts having. The molding of the base layer panels 20-20′″ may advantageously include inner-mold connection of the interface 16, as will be described hereinafter.

In another preferred embodiment, the base layer panels 20-20′″ are molded in expanded polyethylene (i.e., EPE), with a density ranging between 2.0 to 5.0 pcf. EPE has properties such as resilience, flexibility and tear-resistance that make the material well suited for play surfaces that are subjected to high-impact team sports such as soccer and football. An increase in density in EPE results in increased rigidity for the base layer panel 20-20′″. Moreover, the tear-resistance characteristic results in an enhanced resistance of the thinner parts (e.g., tongue 24′) to tears, especially during installation.

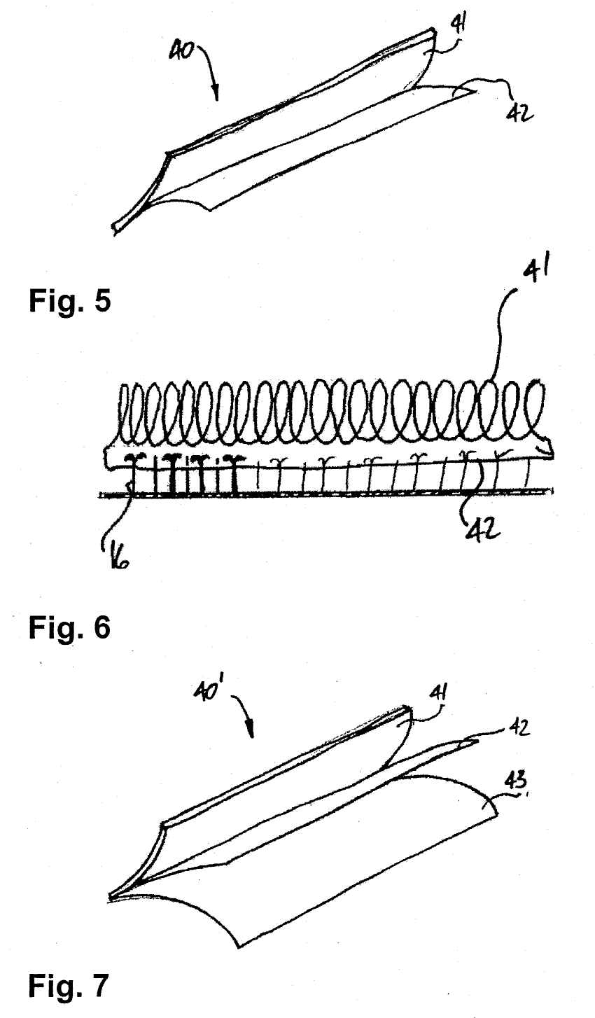

Referring to FIG. 5, a carpeting panel of the surface layer 14 is generally shown at 40, in accordance with the preferred embodiment. The carpeting panel 40 has a fiber subpanel 41 and a textile subpanel 42.

The fiber subpanel 41 is the exposed portion of the surface layer 14. In the preferred embodiment, the fiber subpanel 41 has generally upstanding fibers simulating grass. A range of suitable heights for the fibers is between 0.35 inch and 2.60 inch. The fibers are typically made of a polymeric material, such as polypropylene, polyethylene, polyamide or combination of fibers. The fibers are of different types, such as monofilament, fibrilized, parallel fibrilized, straight, textured. Although not illustrated, a filler can be used between the fibers. Materials for the filler include elastomeric-base fillers, SBR, EPDM, TPR, TPO, elastomer-coated sand, sand, or any combination thereof.

The textile subpanel 42 binds the fibers of the fiber subpanel 41 together. It is considered to have a thermoplastic resin pre-impregnated in the textile subpanel 42.

Referring to FIGS. 7, 11 and 12, another preferred embodiment of the carpeting panel is illustrated as 40′. The carpeting panel 40′ is essentially similar to the carpeting panel 40, whereby in FIGS. 5, 7, 11 and 12, like elements will bear like reference numerals. The carpeting panel 40′ has an additional subpanel, namely loop fabric subpanel 43. The loop fabric subpanel 43 is laminated to the subpanels 41 and 42.

In an embodiment, the loop fabric subpanel 43 is a polyester fiber material, woven or non-woven, for instance of the hoop-type Velcro™, laminated to the subpanels 41 and 42 by flame lamination, thermofusion or the like. The thermoplastic resin of the textile subpanel 42 bonds to the loop fabric subpanel 43. The loops of the subpanel 43 are selected in size and density so as to be complementary to the hooks of the interface 16, to ensure the integrity of the mechanical connection therebetween. Although not necessary, the use of the loop fabric subpanel 43 is suggested when it is anticipated that the play surface will be subjected to high peeling and shearing forces.

Referring concurrently to FIGS. 1 and 6, an interaction between the carpeting panel 40 and the interface 16 is shown. In the preferred embodiment, the interface 16 is a hook strip of Velcro™ (e.g., low-profile hooks). The size and density of the hooks of the strip are chosen as a function of the meshing of the textile subpanel 42 or of the loop fabric subpanel 43, in such a way that the interface 16 connects directly to the textile subpanel 42 or loop fabric subpanel 43.

For instance, the hook strips of the interface 16 are between 1.5 and 2.0 inches for the recesses 26′ of FIGS. 8 to 10, so as to be fully accommodated in the recesses 26′. Similarly, the hook strips of the interface 16 are between 3.5 and 4.0 inches for the recess 27 of FIGS. 8 to 10. The material of the hook strips is selected as a function of the conditions of use of the play surface, such as weather conditions, humidity exposure, resistance to shearing forces and traction, and UV-ray exposure. Materials considered include polypropylene, nylon and polyester, amongst others.

The interface 16 typically has a strong adhesive so as to be secured to the top surface of the base layer 12. As is shown in the embodiment of FIG. 8, the interfaces 16 are strips 16A of material, such as hook portions of Velcro™, that are sized so as to be accommodated in the recesses 26′ and 27. Adhesive 16B is used to secure the strips 16A in the recesses 26′ and 27. More specifically, one method considered to assure a suitable bond between the interfaces 16 and the panels of the base layer 12 is to permanently laminate the interfaces 16 directly to the base panel layers 12 (e.g., in the recesses 26′ and 27 as illustrated in FIGS. 8 to 10). Another method is to insert the strips 16A and adhesive 16B in the mold forming the base layer panel 20-20′″, for inner-mold lamination of the strips 16A to the base layer panel 20-20′″.

Accordingly, with these preferred embodiments, no time is spent on site securing the interfaces 16 to the panels of the base layer 12. Installation is therefore accelerated by the pre-installation lamination of the interfaces 16 to the base layer panels 20-20′″.

However, factors such as exposure to harsh weather conditions may affect the bond between the base layer 12 and the interfaces 16. For instance, thermal contraction may occur, whereby the materials used for the interfaces 16 must be in such cases compatible (both mechanically and chemically) to the material of the base layer 12. It is therefore considered to use polypropylene-based interfaces 16 with EPE panels 20-20′″. Advantageously, such materials can be recycled.

It is considered to fuse or laminate the interfaces 16 to the base layer panels 20-20′″. One process that is considered involves a thermo-activated adhesive 16B, such as a olefin-based resin. The strips 16A and adhesive 16B are positioned on the base layer panels 20-20′″ (e.g., in the appropriate recesses 26′, 27).

The assembly is then pressed under heat, or exposed to infrared heat. As an example, a 25 g/m² olefin-based resin is activated below 100° C. in a time span going from 15 to 30 seconds. As the temperature of fusion of the resin is lower that of the materials involved (EPE, polypropylene), the materials will not deteriorate because of the heating/pressing steps. The heating/pressing steps are followed by a cooling step (e.g., 60-90 seconds), to ensure the stability of the bond.

In the embodiment illustrated in FIG. 1, the interface 16 is positioned at the seam between a pair of carpeting panels 40. Although a plurality of factors are to be taken into account in the sizing of the interface 16, it is considered that an overlap of 3 inches between each panel 40 and the interface 16 is suitable to sustain peeling and shearing forces to which the surface layer 14 is subjected.

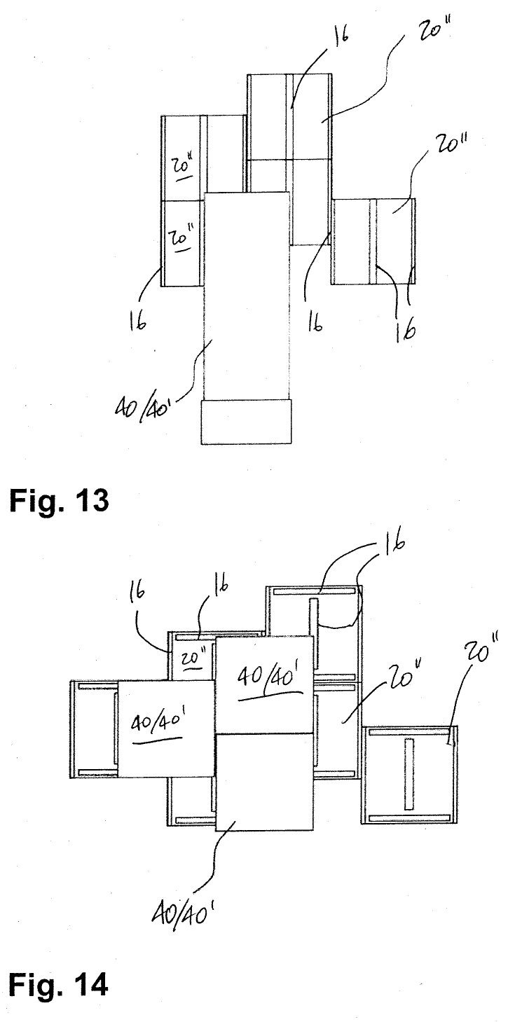

Referring to FIGS. 13 and 14, the base layer panels 20-20′″ (i.e., panels 20″ in FIGS. 13 and 14), are positioned end to end in one orientation, and side by side in the other orientation, but with the end-to-end joints not aligned. This provides an additional structural stability to the base layer 12.

In order to install the carpeting panels 40/40′ in the embodiment of FIG. 13, a roll of carpeting panel 40/40′ is unrolled such that the carpeting panel 40/40′ covers the joint between side-by-side panels 20-20′″. The interfaces 16 connect to the undersurface of the carpeting panel 40/40′ by the combined action of the connectors (i.e., Velcro™) This unrolling solution is relatively fast to perform.

In order to install the carpeting panels 40/40′ in the embodiment of FIG. 14, carpeting panels 40/40′ in the form of rectangular mats cover the joints between end-to-end panels 20-20′″ and/or side-by-side panels 20-20′″. The interfaces 16 connect to the undersurface of the carpeting panels 40/40′ by the combined action of the connectors (i.e., Velcro™). This solution is not as fast to perform as the solution of FIG. 13, but does not involve the manipulation of a roll, whereby it is not as demanding physically for the installer.

In order to install the carpeting panels 40/40′ on the base layer 12 as illustrated in FIG. 4, the carpeting panels 40/40′ are laid onto the top surface of the base layer 12. The interfaces 16 at in the recesses 26′ (FIGS. 8-10) are positioned at the joint between the panels 40/40′, and bonded to the top surface of the base layer 12. Pressure is then applied onto the panels 40/40′ at the joints therebetween, opposite the interfaces 16.

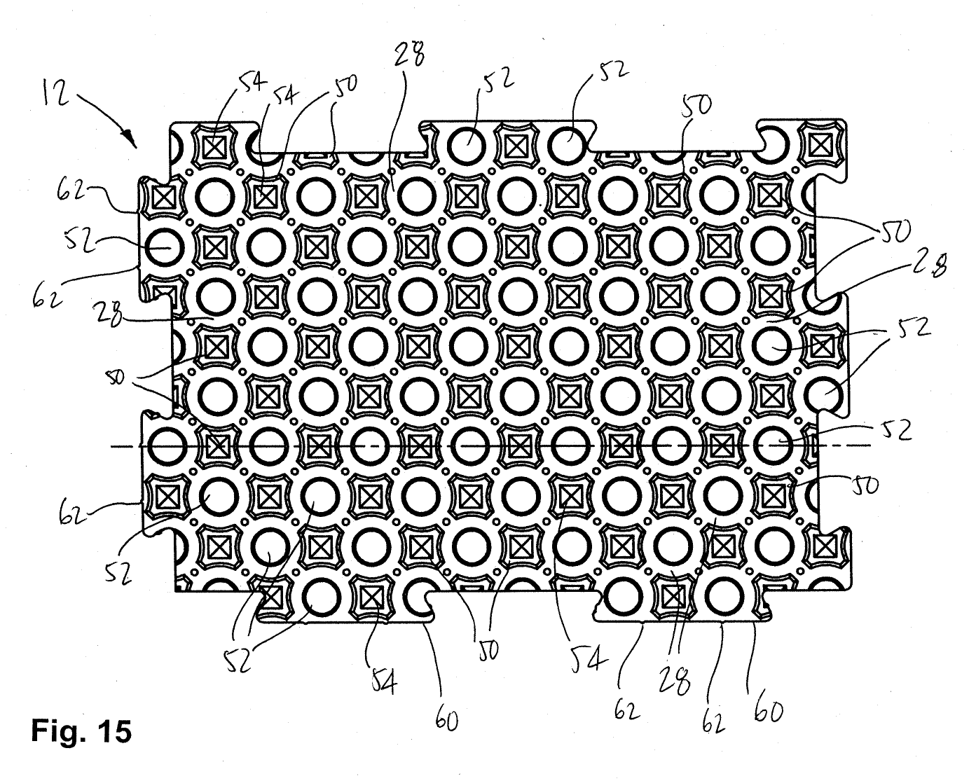

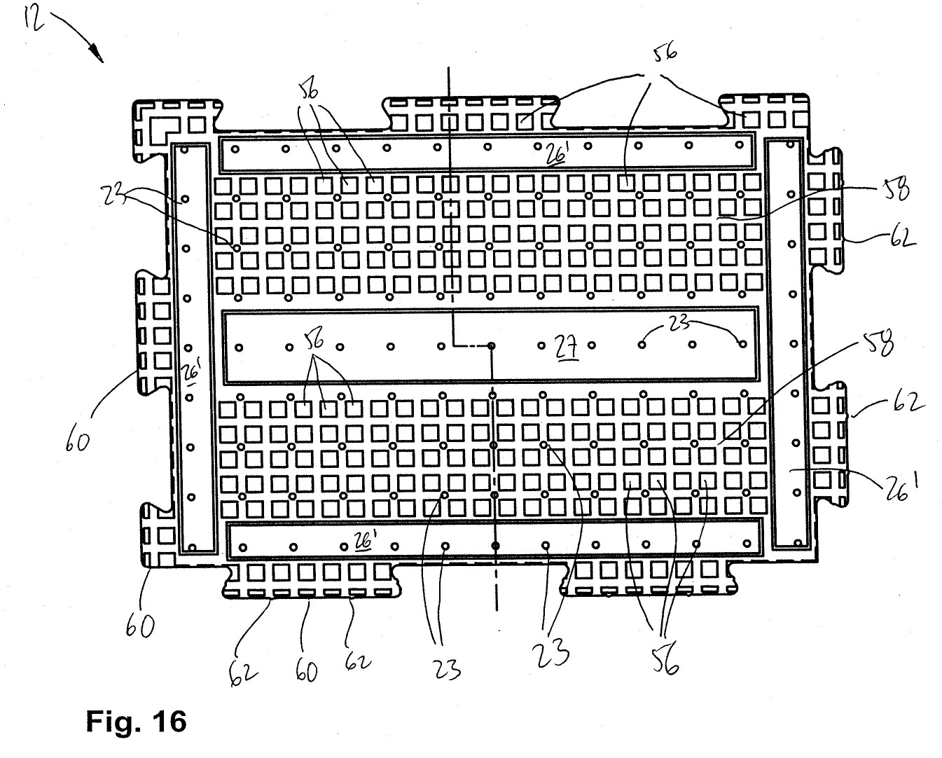

Referring to FIGS. 15 and 16, another preferred embodiment of the base layer 12 is illustrated. As depicted in FIG. 15, the base layer 12 defines the drainage recesses 28 by a pattern of structural supports 50 and absorption supports 52, namely structural posts and absorption posts. The structural supports 50 each have a generally tetragonal section, with a tapering geometry. However, when zoomed in, the structural supports 50 have arcuate walls adjacent to the absorption supports 52, to ensure a suitable spacing between the supports 50 and 52, ta facilitate the drainage of liquids through the recesses 28.

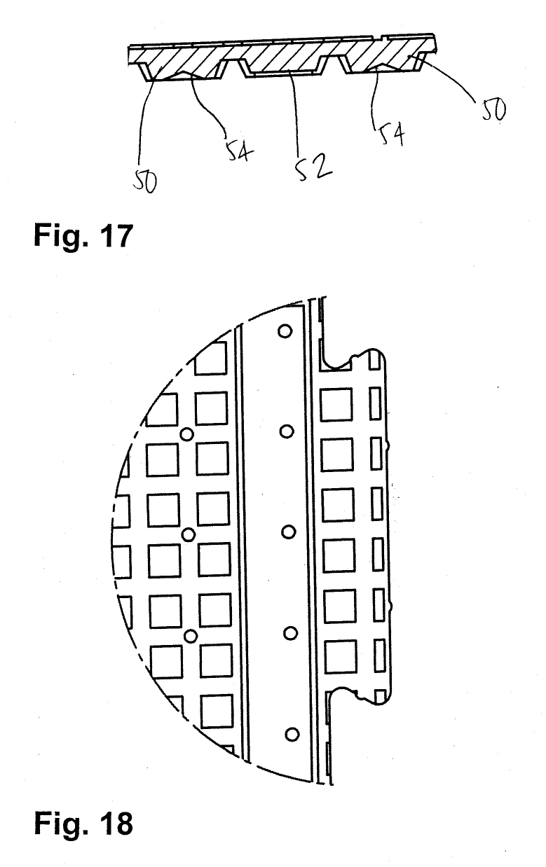

The absorption supports 52 each may have a circular section. As illustrated in FIGS. 15 and 17, the supports 52 may also have a frusto-conical geometry. Referring to FIG. 17, the absorption supports 52 are shown as being slightly shorter than the structural supports 50. Therefore, this creates a gap between the bottom of the absorption supports 52 and the ground when the base layer 12 is laid on the ground. As a result, pressure on top of the base layer 12 of FIG. 15 may result in a deformation of the base layer 12 opposite the supports 52, and thus a downward movement of the supports 52 to contact the ground. Accordingly, impact energy is partially absorbed by this deformation. Subsequently, the base layer 12 returns to its initial shape by its resilience, causing a rebounding effect.

Referring to FIG. 15, the structural supports 50 preferably have a concavity 54 at their free ends. The concavities 54 may act as suction cups, for instance when pressed to the ground by impact pressure on the base panel 12. Accordingly, the adherence of the base panel 12 to the ground may be increased by the presence of the concavities 54.

Referring concurrently to FIGS. 16 and 17, the top surface of the base layer 12 has a pattern of protuberances 56. The protuberances 56 define channels 58 therebetween, which channels allow the drainage of liquids through the bores 23. The protuberances 56 increase the contact surface between the base layer 12 and the surface layer 14. Moreover, the protuberances 56 have edges that may increase the friction between the base layer 12 and the surface layer 14, to prevent tearing off of the surface layer 14. The protuberances 56 may have a square section, as illustrated in FIG. 16.

Referring concurrently to FIGS. 16 and 18, the base layer 12 has connectors 60 projecting laterally from edges of the base layer 12. The connectors 60 have a dovetail shape, and therefore define dovetail slots between them. Accordingly, sets of the base layer 12 may be interconnected to one another by the connectors 60. It is pointed out that the connectors 60 at the corners of the base layer 12 may be half dovetails, so as to allow base layers 12 to be interconnected in the manner shown in FIG. 4.

Considering that the base layers 12 may be exposed to heat (e.g., sun) and may thus expand thermally, bosses 62 are provided at various locations on the connectors 60 to prevent base layers 12 for fusing with one another. The bosses 62 reduce the surface contact at the dovetail joints between adjacent base layers 12, and leave a small air gap between surfaces in the joint. Accordingly, the base layers 12 may be detached with more ease because of the bosses 62.

In an alternative embodiment, it is considered to laminate the carpeting panels 40 to the base layer 12 by applying heat to the carpeting panels 40 to fuse the thermoplastic resin of the textile subpanel 42 (FIG. 5).

It is pointed out that the pressure exerted on the surface layer 14 by users of the play surface will ensure the integrity of the connection between the carpeting panel 40 and the interface 16.

1. A play surface layer structure, comprising:
a base layer having panels joined in side-by-side relation, each of the panels being formed of an impact-absorbing material;
a surface layer having carpeting panels positioned in side-by-side relation atop the base layer so as form an exposed surface of the play surface layer structure; and
textile interfaces between the base layer and the surface layer, the interfaces securing the surface layer to the base layer.

2. The play surface layer structure according to claim 1, wherein the panels of the base layer are joined in side-by-side relation by any one of flange-and-shoulder, dovetail and tongue-and-groove configurations.

3. The play surface layer structure according to claim 1, wherein the textile interfaces are hook-type Velcro™ strips cooperating directly with a textile subpanel of the carpeting panels, or with a sublayer of hoop-type Velcro™ on an underside of the surface layer.

4. The play surface layer structure according to claim 1, wherein recesses are defined in an upper surface of the panels of the base layer to accommodate the textiles interfaces such that the upper surface of the panels of the base layer is coplanar with an upper surface of the textile interfaces.

5. The play surface layer structure according to claim 4, wherein the textile interfaces are hook-type Velcro™ strips received in two parallel recesses provided on the contour of each of the panels of the base layer, and in a recess centrally provided in the panel of the base layer, with the recesses being parallel to one another, to cooperate directly with a textile subpanel of the carpeting panels.

6. The play surface layer structure according to claim 5, further comprising two additional parallel recesses provided on the contour of each of the panels of the base layer, the additional parallel recesses being perpendicular to the three other recesses.

7. The play surface layer structure according to claim 1, wherein the panels of the base layer are molded in expanded polyethylene at a density ranging between 2.0 and 5.0 pcf.

8. The play surface layer structure according to claim 5, wherein the hook-type Velcro™ strips are laminated into the recess using an adhesive.

9. The play surface layer structure according to claim 1, wherein the carpeting panels of the surface layer each have a fiber subpanel having upstanding fibers simulating grass, and a textile subpanel binding the fibers of the fiber subpanel together.

10. The play surface layer structure according to claim 9, wherein the carpeting panels further comprise a subpanel of hoop-type Velcro™ on an underside of the textile subpanel.

11. The play surface layer structure according to claim 9, wherein the carpeting panels are elongated into a roll for being installed.

12. The play surface layer structure according to claim 1, further comprising an underbase layer having panels with a density different than the density of the panels of the base layer.

13. The play surface layer structure according to claim 12, wherein the panels of the underbase layer have a top surface of shape complementary to a shape of a bottom surface of the panels of the base layer for mechanical engagement therebetween.

14. The play surface layer structure according to claim 1, wherein the carpeting panels are positioned on the base layer such that each carpeting panel overlaps at least four of the panels of the base layer.

15. The play surface layer structure according to claim 1, wherein recesses are provided in an undersurface of the panels of the base layer to reduce a weight of the panels of the base layer.

16. The play surface layer structure according to claim 1, wherein posts project from an underside of the panels of the base layer to define recesses to allow drainage of liquids in the recesses.

17. The play surface layer structure according to claim 16, wherein the posts comprises a pattern of structural posts and absorption posts, with the structural posts being vertically longer than the absorption posts, whereby a clearance is defined between a bottom of the absorption posts and the ground so as to allow deformation of the panels of the base layer at the absorption posts by movement of the posts in the clearance.

18. The play surface layer structure according to claim 17, wherein the structural posts each have a concavity on a bottom surface to cause suction of the structural posts on the ground.

19. The play surface layer structure according to claim 1, further comprising protuberances on a top surface of the panels of the base layer to increase a contact area between the base layer and the surface layer.

20. The play surface layer structure according to claim 19, wherein channels are formed between the protuberances, and drainage bores are defined through the panels of the base layer and in fluid communication with the channels for drainage of liquids through the base layer.

21. The play surface layer structure according to claim 1, wherein the panels of the base layer are joined in side-by-side relation by dovetail connectors, and lateral surfaces of the dovetail connectors have spacing means to reduce a contact surface between the panels of the base layer.
